(19) United States
(12) Patent Application Publication
(10) Pub. No.: US 2002/0147779 A1
(43) Pub. Date: Oct. 10, 2002

(54) Method and computer program product for providing email that guides a recipient through a set of associated web pages

(75) Inventors: Cary Lee Bates, Rochester, MN (US); Paul Reuben Day, Rochester, MN (US); John Matthew Santosuosso, Rochester, MN (US); Waheed Sujjad, Nashville, TN (US)

Correspondence Address: David R. Irvin, IBM Corporation T81/B503, PO Box 12195, Research Triangle Park, NC, 27709, US

(73) Assignee: International Business Machines Corporation, Armonk, NY (US)

(21) Appl. No.: 09/827,233

(22) Filed: Apr. 5, 2001

(51) Int. Cl. G06F 15/16

(52) U.S. Cl. 709/206

(57) ABSTRACT

A method and computer program product for guiding the recipient of an email through a set of web pages carried by the email in a preferred viewing order. An originator's email program composes an email and a navigation. The navigation includes a set of URLs that identify web pages to be viewed by the recipient and a preferred viewing order. The email and the navigation are sent to the recipient. The recipient's email program passes the navigation to the recipient's web browser. The recipient's web browser displays an indication of the preferred viewing order. In various embodiments, the preferred viewing order is displayed by the use of link colors, by font type or size, by icons, or by an order loaded into the forward-and-backward memory of the recipient's web browser.

### FIELD OF THE INVENTION

The present invention is related to the field of electronic mail (email), and more specifically to providing an effective way of including reference to a set of Internet World Wide Web pages in an email and guiding the recipient of the email through the web pages in a preferred viewing order.

### BACKGROUND

Both electronic mail (email) and the Internet-based World Wide Web have so far proven to be invaluable tools that are widely used by a large and diverse population. Yet today these two fundamental building blocks of the information age remain relatively independent.

For example, an originator may wish to send email to a recipient, where the email instructs the recipient to visit a set of web pages. In such a situation, the e-mail may include a list of links to web pages that the recipient is to view in a preferred order. Once the recipient leaves the email to view the first web page, however, he can no longer see the list of links carried by the email, and must return to the email to get an address or a link to a succeeding web page. Continuing in this fashion, the recipient then alternates between the email and the web in order to view the web pages in the preferred order. Thus, the recipient of the email is inconvenienced significantly when the need arises to view a set of web pages in a preferred order, when the set of web pages and the preferred viewing order are specified in an incoming email.

One solution to this problem is for the recipient to print a paper copy of the email, and to refer to this paper copy in order to follow the preferred viewing order of the web pages. This presents the recipient with other inconveniences. For example, when printers are networked and shared, the recipient may find that a printer is neither conveniently nor immediately available. Also, the creation of a paper document that includes the email text, the set of web pages, and the preferred viewing order may present a security concern. Further, the printing of a paper copy for short-term use is often wasteful of time and natural resources.

Thus there is a need for a convenient, efficient way of guiding the recipient of an email through a set of web pages carried by links that are included within the email, where the pages are to be viewed in a preferred order.

### SUMMARY OF THE INVENTION

In response to the aforementioned need, the present invention provides an efficient and convenient way of guiding the recipient of an email through a set of web pages carried by links included in the email in a preferred viewing order that is specified by the originator of the email.

According to one embodiment of the present invention, an email program composes an email in response to the input of an originator, and, further in response to input of the originator, the email program and the originator's web browser together generate a navigation.

The navigation includes a set of URLs that identify web pages to be viewed by the recipient and a preferred order in which the recipient is to view the web pages. The navigation is associated with the email, for example by use of an identification number or by incorporation into the email, and both the email and the navigation are sent to the recipient. The recipient's email program receives the email and the navigation, and passes the navigation to the recipient's web browser. The recipient's web browser then displays an indication of the preferred order in which the recipient is to view the web pages.

In one embodiment of the present invention, the preferred viewing order is displayed to the recipient by link colors. The navigation carries a list of URLs and, in association with each URL, a color to be used by the recipient's web browser when displaying links to the web page identified by the URL.

For example, an incoming email may instruct the recipient to access green links before red links, and may include a green link to open a first web page and a red link to another page to be opened later on. Upon opening the first web page, the recipient may be presented with other links to other web pages. According to the present invention, these other links to other web pages are themselves color coded, so that the recipient may determine which of the other pages to open next. For example, the first web page may display a link that is green, which is called here the second green link, along with a link that is red and a link that is some other color. The recipient now knows, without referring back to the text of the email, to next open the web page identified by the second green link, called here the second web page. Upon opening the second web page, the recipient may see a third green link, and know to open a third web page identified by the third green link. Upon reaching the end of the thread of green links, the recipient may return to the text of the email and begin to work through the thread of red links in like manner.

In a variation of this embodiment, the preferred viewing order may be conveyed to the recipient by causing the next link in the preferred viewing order to change colors rapidly, for example alternating between red and green, or to appear and disappear from the screen in rapid succession.

The present invention, however, is not restricted to the use of link colors to convey the preferred viewing order to the recipient. In another embodiment of the invention, font characteristics such as size or typeface are used to indicate the preferred viewing order. For example, the link to be viewed next in the preferred viewing order may be displayed with a larger-than-normal font or in an eye-catching typeface.

In yet another embodiment of the invention, icons are associated with URLs that identify web pages to be viewed. The icons are displayed alongside or otherwise nearby links to the associated URLs, so that the icons convey the preferred viewing order to the recipient. For example, the icons may include indicators similar to golf course flags, that label each link with its rank in the preferred viewing order. For example, a small flag bearing the numeral 1 may be placed alongside links in the first-tier of the preferred viewing order, a small flag bearing the numeral 2 placed alongside second-tier links, and so forth.

In another embodiment of the invention, the preferred viewing order is loaded from the navigation into the forward-and-backward page memory of the receiving web browser, and thereby implicitly conveyed to the recipient. The recipient traverses from page to page according to the preferred viewing order by operating the browser's forward and backward controls.

Thus the present invention enables the recipient of an email to access a set of web pages associated with the email in a particular viewing order intended by the originator of the email. These and other aspects of the present invention will be more fully appreciated when considered in light of the following detailed description and drawings.

### BRIEF DESCRIPTION OF THE DRAWINGS

FIG. 1 is a block diagram that shows an environment of the present invention.

FIG. 2 is a flowchart that shows aspects of the operation of the invention.

FIGS. 3A, 3B, and 3C are diagrams that show exemplary embodiments of web page navigations suitable for use in the operation depicted by FIG. 2.

FIG. 4 shows an example of the construction of a web page navigation in further detail.

### DETAILED DESCRIPTION OF THE INVENTION

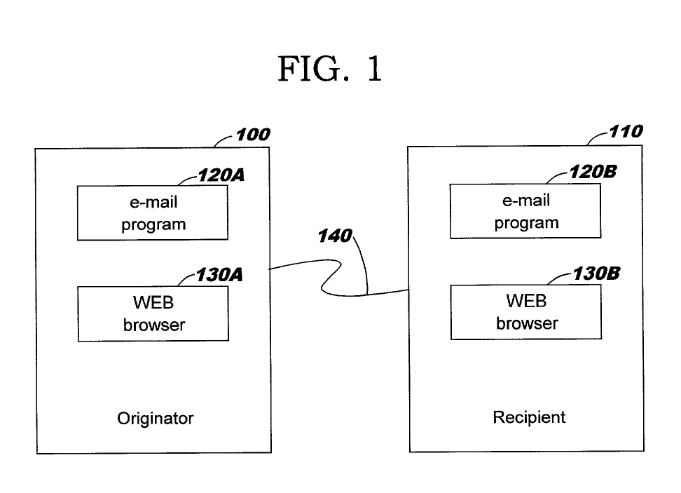

The present invention may be cast in the environment of FIG. 1, wherein an originator 100 sends an email to a recipient 110 over a communication link 140. The email includes a set of URLs that identify web pages to be viewed by the recipient 110 in a preferred viewing order as specified by the originator 100. As shown in FIG. 1, the originator 100 and the recipient 110 each include an email program 120A and 120B and a web browser 130A and 130B.

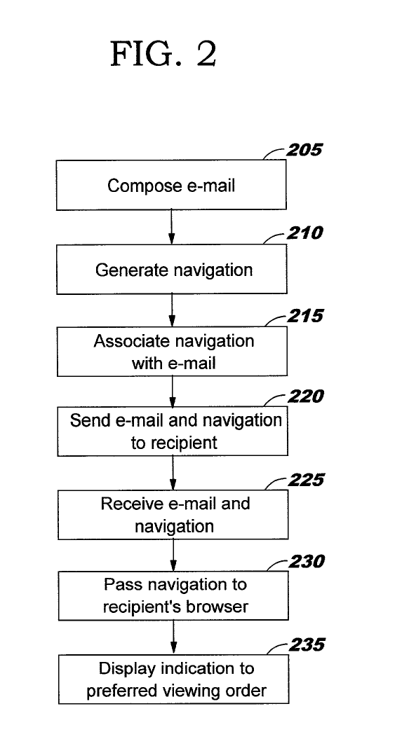

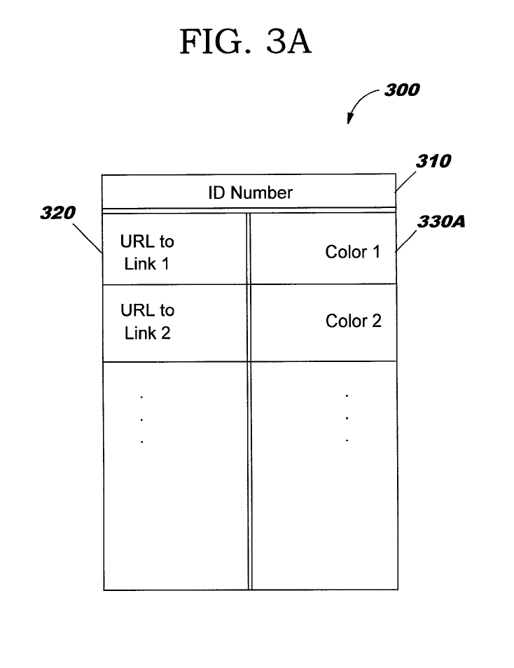

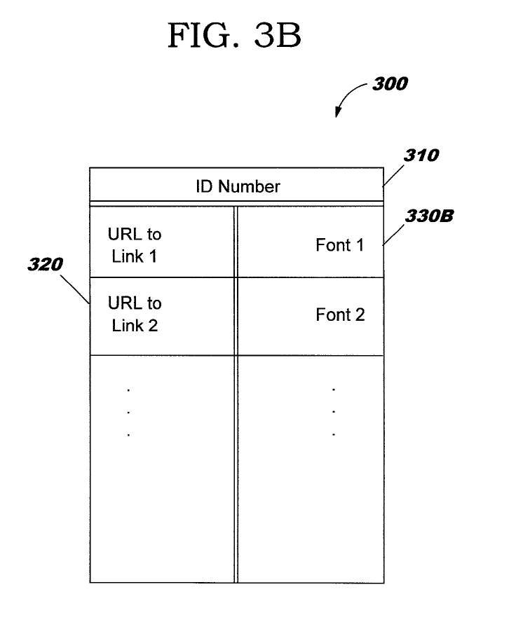

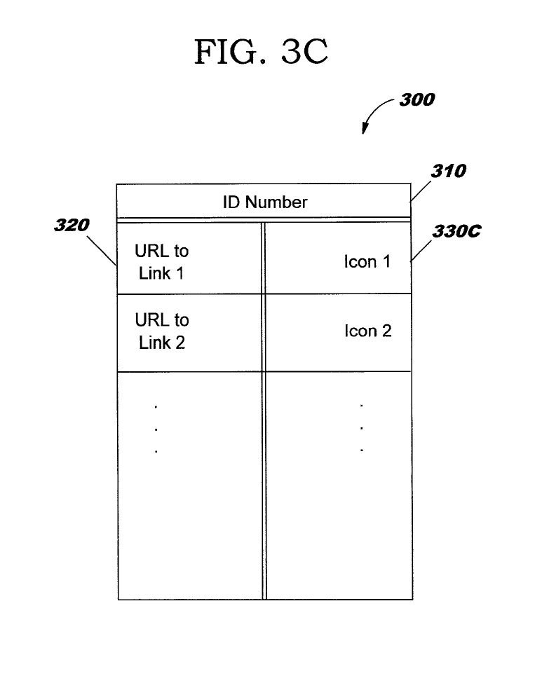

As shown in FIG. 2 with reference to FIGS. 3A-3C, the originator's email program 120A composes the email in response to input of the originator 100 (step 205). Further in response to input of the originator 100, the originator's email program 120A, together with the originator's web browser 130A, generates a web page navigation 300 (step 210). As described in further detail below, the navigation 300 includes a set of URLs that identify web pages to be viewed by the recipient 110 and a preferred order in which the recipient 110 is to view the web pages. The navigation 300 is associated with the email (step 215), for example by use of an identification number 310 or by incorporation of the navigation 300 into the email. Both the email and the navigation 300 are sent to the recipient 110 (step 220). The recipient's email program 120B receives the email and the navigation 300 (step 225), and passes the navigation 300 to the recipient's web browser 130B (step 230). The recipient's web browser 130B then displays an indication of the preferred order in which the recipient 110 is to view the web pages (step 235).

In one embodiment of the present invention, the preferred viewing order is displayed to the recipient 110 by the use of link colors. As shown in FIG. 3A, the navigation 300 may carry a list of URLs 320 and a list of colors 330A, wherein a color is associated with each URL. When displaying a link to a web page identified by a URL selected from the list of URLs 320, the recipient's web browser 130B displays that link in the appropriate color as specified by the list of colors 330A.

For example, an incoming email may instruct the recipient 110 to access green links before red links, and may include a green link to open a first web page and a red link to another page to be opened later on. Upon opening the first web page, the recipient 110 may be presented with other links to other web pages. According to the present invention, these other links to other web pages are themselves color coded, so that the recipient 110 may determine which of the other pages to open next. For example, the first web page may display a link that is green, which is called here the second green link, along with a link that is red and a link that is some other color. The recipient 110 now knows, without referring back to the text of the email, to next open the web page identified by the second green link, called here the second web page. Upon opening the second web page, the recipient 110 may see a third green link, and know to open a third web page identified by the third green link. Upon reaching the end of the thread of green links, the recipient 110 may return to the text of the email and begin to work through the thread of red links in like manner.

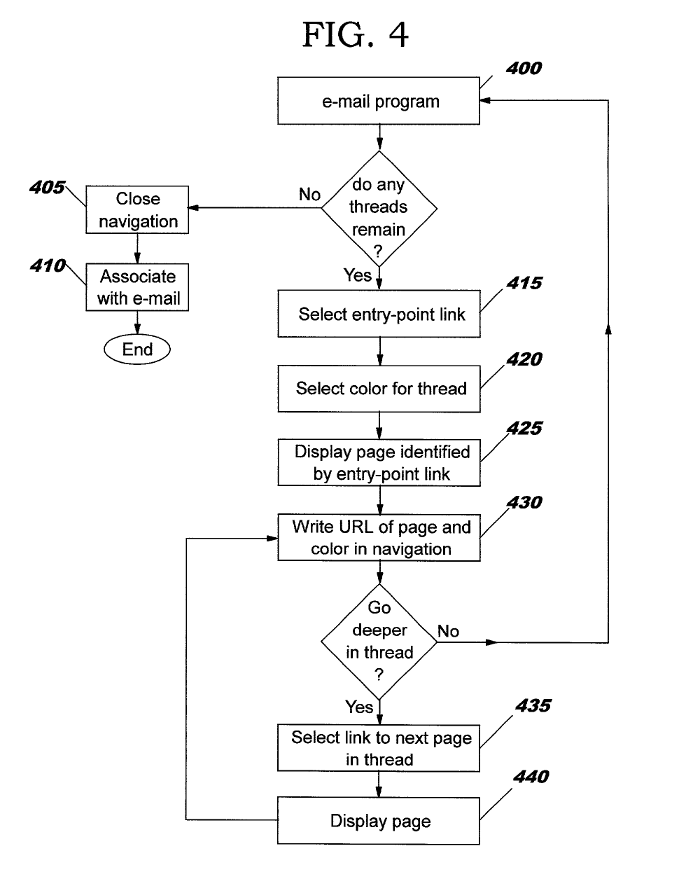

FIG. 4 shows the construction of the navigation 300 in further detail. The particulars of both the navigation 300 and the construction of the navigation 300 as shown in FIG. 4 are exemplary, and are presented here for the sake of clarity rather than limitation. The process of construction begins with entry from the originator's email program 120A (step 400). In this description of the invention, a set of web pages to be viewed in a preferred viewing order is called a thread. A thread begins with a link called here an entry point link, which is displayed by the originator's email program 120A as part of the email sent to the recipient 110. If all of the threads of the email have been incorporated into the navigation 300, for example when the email shows two entry point links and the threads defined by both entry point links have been incorporated into the navigation 300, the navigation 300 is closed (step 405). The navigation 300 is then associated with the email (step 410), for example by the ID number 310 shown in FIG. 3 or by incorporating the navigation 300 into the email, at which point the operation shown in FIG. 4 ends.

Otherwise (i.e., at least one thread remains unincorporated into the navigation 300), the originator 100 selects the next entry point link to the thread (step 415) and a color—or, as described later, another indicator of position in the preferred viewing order—to be associated with the thread (step 420). In response to the selection of the entry point, the originator's web browser 130A displays the web page called by the entry point link (step 425). The URL that identifies the displayed web page and the thread color or other indicator selected by the originator 100 are written into the navigation 300 (step 430).

If the originator 100 goes deeper into the thread, i.e., if the originator 100 specifies a next web page in the preferred viewing order carried by the navigation 300, the originator 100 accesses a link to the next page in the thread (step 435), and the originator's web browser 130A displays the web page linked (step 440). The URL that identifies the displayed web page and the thread color or other indicator selected by the originator 100 are written into the navigation 300 (step 430), and flow proceeds as described above. Otherwise (i.e., the originator does not go deeper into the thread), the originator re-enters the email program (step 400).

As described above, in one embodiment of the present invention the recipient's web browser 130B conveys the preferred viewing order to the recipient 110 by the use of link colors. In a variation of this embodiment of the invention, the preferred viewing order may be conveyed to the recipient by causing the next link in the preferred viewing order to change colors rapidly, for example alternating between red and green, or to appear and disappear from the screen in rapid succession, and so forth.

The present invention is not limited to the use of link colors, however, to convey the preferred viewing order. More generally, the preferred viewing order may be carried in the navigation 300 by other indicators as well, which are called here priorities. A thread is then defined by progressing from highest priority to lowest priority web pages.

For example, in another embodiment of the present invention, the order in which URLs appear in the navigation 300 may itself convey the preferred viewing order of the web pages. Thus, in this embodiment the conveyance of the preferred viewing order by the navigation 300 is implicit rather than explicit. From the implicit navigation 300, the recipient 110 may be guided through the thread, for example by a pop-up window.

In yet another embodiment of the present invention, the navigation 300 may be loaded into the forward-and-backward page memory of the recipient's web browser 130B, and the recipient 110 may view a thread in proper sequence from its entry point link to its end by using the forward and backward controls of the recipient's web browser 130B.

In another embodiment of the invention, font characteristics, for example size or typeface, may be used to convey the preferred viewing order to the recipient 110, wherein the navigation 300 takes the form shown in FIG. 3B. Here, the navigation 300 includes a list of font characteristics 330B, wherein a font characteristic is associated with each URL in the list of URLs 320. When displaying a link to a web page identified by a URL selected from the list of URLs 320, the recipient's web browser 130B displays that link using the font characteristic as specified by the list of font characteristics 330B. For example, the link to be viewed next in the preferred viewing order might be displayed with a larger-than-normal font or in an eye-catching typeface.

In a variation of this embodiment, the links to be viewed are displayed according to the preferred viewing order in fonts that progress in size from large to small.

In yet another embodiment of the invention, the navigation 300 associates icons with URLs that identify web pages to be viewed, wherein the navigation 300 takes the form shown in FIG. 3C. Now the navigation 300 includes a list of icons 330C, wherein an icon is associated with each URL of the list of URLs 320. At the recipient's web browser 130B, icons are displayed alongside or otherwise nearby links to the associated URLs, so that the icons convey the preferred viewing order to the recipient. When displaying a link to a web page identified by a URL selected from the list of URLs 320, the recipient's web browser 130B displays that link using the icon specified by the list of icons 330C. For example, the icons may include indicators similar to golf course flags, labeling each link with its priority or rank in the preferred viewing order—for example, by a small flag bearing the numeral 1 placed alongside first-priority links, a small flag bearing the numeral 2 placed alongside second-priority links, and so forth.

From the foregoing description, those skilled in the art will appreciate that the present invention guides the recipient of an email readily through a set of web pages associated with the email in a preferred viewing order, while relieving the recipient of the need to refer back to the email or to print a paper copy of the preferred viewing order. The foregoing description, however, is illustrative rather than limiting, and the scope of the present invention is limited only by the following claims.

We claim:

1. A method for providing email that enables a recipient of the email to navigate readily through a set of web pages associated with the email, comprising the acts of:
composing an email to be sent from an originator to a recipient;
In response to input of the originator, generating a web page navigation that includes a plurality of uniform resource locators and a preferred viewing order in which web pages identified by the plurality of uniform resource locators are to be viewed by the recipient;
associating the navigation with the email; and
sending the email and the navigation to the recipient.

2. A method for guiding a recipient of an email readily through a set of web pages associated with the email, comprising the acts of:
receiving an email;
receiving a web page navigation associated with the email;
passing the web page navigation to a web browser; and
displaying by the browser a preferred viewing order in which web pages identified by the web page navigation are to be viewed;
wherein the preferred viewing order is included in the navigation.

3. A method for providing email that guides a recipient readily through a set of associated web pages, comprising the acts of:
composing an email to be sent from an originator to a recipient;
in response to input of the originator, generating a web page navigation that includes a plurality of uniform resource locators that identify web pages to be viewed by the recipient in a preferred viewing order;
sending the email and the web page navigation to the recipient;
passing the web page navigation to a web browser used by the recipient; and
displaying by the browser an indication of the preferred viewing order.

4. The method of claim 3, wherein the indication of the preferred viewing order is provided by link colors.

5. The method of claim 3, wherein the indication of the preferred viewing order is provided by icons.

6. The method of claim 3, wherein the indication of the preferred viewing order is provided by font characteristics.

7. The method of claim 3, wherein the indication of the preferred viewing order is provided by forward and backward browser controls.

8. A method for providing email that guides a recipient readily through a set of associated web pages, comprising the acts of:
composing an email to be sent from an originator to a recipient;
in response to input of the originator, generating a navigation that includes:
a plurality of uniform resource locators that identify web pages to be viewed by the recipient; and
a color associated with each of the uniform resource locators according to a color code, wherein the color code indicates a preferred viewing order in which the web pages are to be viewed by the recipient; and
sending the email and the navigation to the recipient.

9. Programmable media containing programmable software for providing email that guides a recipient readily through a set of associated web pages, the programmable software comprising the acts of:
composing an email to be sent from an originator to a recipient;
in response to input of the originator, generating a web page navigation that includes a plurality of uniform resource locators and a preferred viewing order in which web pages identified by the plurality of uniform resource locators are to be viewed by the recipient;
associating the navigation with the email; and
sending the email and the navigation to the recipient.

10. Programmable media containing programmable software for providing email that guides a recipient readily through a set of associated web pages, the programmable software comprising the acts of:
receiving an email;
receiving a web page navigation associated with the email;
passing the web page navigation to a web browser; and
displaying by the browser a preferred viewing order in which web pages identified by the web page navigation are to be viewed;
wherein the preferred viewing order is included in the web page navigation.

11. Programmable media containing programmable software for providing email that guides a recipient readily through a set of associated web pages, the programmable software comprising the acts of:
composing an email to be sent from an originator to a recipient;
in response to input of the originator, generating a web page navigation that includes a plurality of uniform resource locators that identify web pages to be viewed by the recipient in a preferred viewing order;
sending the email and the web page navigation to the recipient;
passing the web page navigation to a web browser used by the recipient; and
displaying by the browser an indication of the preferred viewing order.

12. The method of claim 11, wherein the indication of the preferred viewing order is provided by link colors.

13. The method of claim 11, wherein the indication of the preferred viewing order is provided by icons.

14. The method of claim 11, wherein the indication of the preferred viewing order is provided by font characteristics.

15. The method of claim 11, wherein the indication of the preferred viewing order is provided by forward and backward browser controls.

16. Programmable media containing programmable software for providing email that guides a recipient readily through a set of associated web pages, the programmable software comprising the acts of:
composing an email to be sent from an originator to a recipient;
in response to input of the originator, generating a navigation that includes:
a plurality of uniform resource locators that identify web pages to be viewed by the recipient; and
a color associated with each of the uniform resource locators according to a color code, wherein the color code indicates a preferred viewing order in which the web pages are to be viewed by the recipient; and
sending the email and the navigation to the recipient.
